(19) United States
(12) Patent Application Publication
(10) Pub. No.: US 2022/0318461 A1
(43) Pub. Date: Oct. 6, 2022

(54) Method and Device for Predicting and/or Reducing the Deformation of a Multipart Assembly

(71) Applicant: Bayerische Motoren Werke Aktiengesellschaft, Muenchen (DE)

(72) Inventors: Michael FLEISCHER, Muenchen (DE); Sebastian ROESEL, Pielenhofen (DE)

(21) Appl. No.: 17/613,389

(22) PCT Filed: Apr. 9, 2020
(86) PCT No.: PCT/EP2020/060126

§ 371 Date: Nov. 22, 2021

(30) Foreign Application Priority Data
May 23, 2019 (DE) 10 2019 113 805.1

(51) Int. Cl. G06F 30/23; B23K 31/00; G06F 30/15

(52) U.S. Cl. CPC G06F 30/23; B23K 31/003; G06F 30/15; B23K 2101/006

(57) ABSTRACT

An apparatus for predicting and/or reducing a deformation of an assembly brought about during production of a weld seam that connects a first component and a second component of the assembly includes a device that is configured to determine and/or provide a finite element (FE) model of the assembly where the FE model includes a set of FEs for the weld seam and a set of FEs for the first component and the second component. The device is further configured to induce a spatial contraction of the set of FEs for the weld seam, determine an effect of the spatial contraction on the set of FEs for the first component and/or the second component, and predict a spatial deformation of the first component and/or of the second component on a basis of the effect on the set of FEs for the first component and/or the second component.

### BACKGROUND AND SUMMARY OF THE INVENTION

The invention relates to a method and a corresponding device which make it possible to predict and/or to reduce the geometric distortion of an assembly which consists of a plurality of components connected to one another via one or more weld seams.

A vehicle typically has different multipart assemblies, in the case of which at least two components are respectively connected to one another via one or more linear weld seams. For example, for a vehicle door, a relatively stable structural component can be connected to a relatively easily deformable outer skin component by means of one or more weld seams, the outer skin component constituting the outer form of the vehicle door. In the course of the welding process for connecting the two components, it is possible that a geometric distortion is brought about, which leads to visible deformations on the outer skin component.

Deformations which are produced during the generation of weld seams can typically be detected only at a relatively late stage of the development of an assembly and/or can be predicted only using relatively complex thermomechanically coupled models for the assembly.

The present document is concerned with the technical object of being able to detect and/or avoid and/or reduce deformations brought about when welding a multipart assembly together already at an early stage in the course of a development process and/or in an efficient manner.

The object is achieved by the independent claims. Advantageous embodiments are described inter alia in the dependent claims. It should be noted that additional features of a patent claim that is dependent on an independent patent claim may form a separate invention without the features of the independent patent claim, or only in combination with some of the features of the independent patent claim, which stands on its own and is independent of the combination of all features of the independent patent claim and which can be made the subject matter of an independent claim, a divisional application or a subsequent application. This applies in the same way to technical teachings described in the description, which can form an invention that is independent of the features of the independent patent claims.

According to one aspect, a device (e.g., a computer and/or a server) for predicting and/or for reducing the deformation of a multipart assembly is described. In particular, the device is configured to predict and/or to reduce the deformation of the assembly brought about during production of at least one weld seam for connecting a first component and a second component of the assembly. In other words, the device can be configured to predict and/or to reduce deformation of a multipart assembly brought about in the course of a welding process (in particular a laser welding process and/or a tactile and/or remote welding process). The aspects described in the present document may be applied in general to welding processes in which a linear and/or elongated weld seam is produced between two components. The device described in the present document may be part of a CAD (Computer Aided Design) system.

The first component may have a relatively high stiffness, and the second component may have a relatively low stiffness. In other words, the second component may be relatively easily deformable in comparison with the first component. The second component may consist, for example, of a relatively thin metal sheet (e.g., with a thickness of 0.5 cm or less). In one example, the assembly is a door or flap (in particular a door or flap of a vehicle). The first component may form a load-bearing structure of the door or flap and the second component may form an outer skin of the door or flap.

The device is configured to determine and/or provide a finite element (FE) model of the assembly. In this respect, the FE model comprises a set of FEs for the weld seam and a set of FEs for the first and the second component. The weld seam may extend linearly between the first component and the second component (e.g., along an edge of the first component and along an edge of the second component). In this respect, the weld seam may have a length which is significantly (in particular by a factor of 5 or more, 10 or more, or 50 or more) larger than the thickness and/or the width of the weld seam. The FE model may describe the complete and/or the entire weld seam right at the beginning of a simulation. In that case, the set of FEs for the (entire) weld seam may comprise a linear sequence of FEs that corresponds to the weld seam. An FE model for the assembly that (already at the beginning of the simulation) comprises a set of FEs for the entire weld seam between the first component and the second component can consequently be provided.

The individual FEs of the FE model typically each have a specific spatial extent (e.g., in the form of a three-dimensional cuboid or beam). Furthermore, an FE typically comprises a mechanical (mathematical) model, which describes what effect a force applied to an edge of the FE has on the spatial extent of the FE. Adjacent FEs are typically mechanically coupled to one another, such that a change in the spatial extent of an FE applies a force to a directly adjacent FE, as a result of which in turn a change in the spatial extent of the directly adjacent FE can be brought about.

It is possible to provide an FE model in a basic state in which the first component and the second component have the form that the first component and the second component have before the welding process, i.e., before the production of the weld seam. In this respect, in the basic state the FE model already comprises the entire weld seam between the first component and the second component. In that case, the FE model for the (entire) weld seam may comprise FEs which connect the FEs of the (undeformed) first component to the FEs of the (undeformed) second component. In this respect, in the basic state preferably no forces are applied by an FE for the weld seam to an FE of the first and/or the second component. This applies preferably for all FEs of the weld seam.

The device may be configured to induce a spatial contraction of the set of FEs for the weld seam. In other words, in the course of a simulation, a reduction in the spatial extent of the FEs for the weld seam (in particular along the length of the weld seam) may be induced. In this respect, a spatial contraction by a specific contraction factor can be brought about (in order to bring about the situation in which the weld seam, proceeding from the basic state, has a length reduced by the contraction factor). The contraction factor may be applied to the individual FEs of the set of FEs for the weld seam. In particular, the spatial contraction may be distributed uniformly over the set of FEs for the weld seam.

The device is also configured to determine and/or to simulate the effect of the spatial contraction of the set of FEs for the weld seam on the set of FEs for the first and/or the second component. In this respect, the contraction may be brought about gradually (e.g., in a sequence of time increments) in order to determine and/or to simulate the continuing effects gradually (e.g., in the sequence of time increments).

As a result of the spatial contraction of the FEs for the weld seam, forces are typically applied to individual FEs of the first component and/or of the second component. These forces lead in turn to a change in the spatial extent of the individual FEs of the first component and/or the second component. These changes and/or effects on the individual FEs may be determined in the course of an FE simulation.

The device is also configured to predict the spatial deformation of the first component and/or of the second component on the basis of the effect on the set of FEs for the first and/or the second component. In particular, one or more locations at which the first and/or the second component are deformed as a result of the production of the at least one weld seam can be predicted.

The device makes it possible to efficiently (without using a thermomechanical model and/or without taking into account parameters with respect to the welding process and/or with respect to the welding tool) predict, and reduce on the basis thereof, the effects of the production of a weld seam. In this way, the costs of a multipart assembly can be reduced and the quality of the assembly produced can be increased.

In particular, the device described does not perform a progressive buildup of the weld seam in order to simulate the production of the weld seam in a manner analogous with reality. For an FE simulation, from the beginning of the FE simulation the device uses an FE model of the assembly that already comprises a set of FEs for the entire weld seam. In other words, the set of FEs for the weld seam can describe the entire weld seam between the first component and the second component already at the beginning of an FE simulation for determining the effect of the spatial contraction on the set of FEs for the first and/or the second component (i.e., as the weld seam should actually be produced). This makes it possible to significantly reduce the complexity of the simulation.

Furthermore, the device described typically does not use any data with respect to a welding installation and/or welding tool and/or with respect to the kinematics of the welding installation and/or of the welding tool that influence the real assembly process of the assembly. Instead, the effects of the welding process are efficiently (if appropriate, solely) simulated by a contraction of the FE model of the entire weld seam between the first component and the second component.

The device may be configured to determine one or more (reference) properties of the first component and/or of the second component. Exemplary (reference) properties are: the material of the first component and/or of the second component, and/or the material thickness of the first component and/or of the second component.

The degree of the contraction to be induced, in particular the contraction factor for the contraction of the weld seam, can in that case be determined in a precise manner on the basis of the one or more reference properties of the first component and/or the second component. In particular, the degree of the contraction to be induced can be determined on the basis of predetermined characteristic data, wherein the characteristic data indicate a respective degree of the contraction to be induced for a multiplicity of combinations of one or more different reference properties of a first reference component and/or a second reference component. The characteristic data may have been determined, for example, by means of (thermomechanical) simulations and/or on the basis of measurements made on actual assemblies in advance.

The determination of a degree of the contraction and/or a contraction factor on the basis of predetermined characteristic data and/or on the basis of (reference) properties of the first and/or the second component makes it possible to predict and/or reduce the deformation of the assembly in a particularly precise manner.

The device may be configured to iteratively and/or repeatedly adapt the first and/or the second component (in particular the FE model of the first and/or of the second component) (in particular with respect to the form and/or the material used). In that case, the deformation can be predicted repeatedly. This makes it possible for the first component and/or the second component to be iteratively and/or repeatedly adapted in order to produce an assembly with a reduced degree of deformation.

In particular, the device may be configured to repeatedly adapt the FE model of the assembly for the first component and/or for the second component, in order to determine a respective adapted FE model. In particular, the device may be configured to adapt the geometric form and/or a material property (e.g., the material thickness) of the first component and/or of the second component, in order to determine the adapted FE model.

In that case, a respective spatial contraction of the set of FEs can be induced for the weld seam of the respectively adapted FE model, and the effect of the spatial contraction on the set of FEs for the first and/or the second component of the adapted FE model can be determined. The respective degree of the spatial deformation of the first component and/or the second component can also be determined on the basis of the effect on the set of FEs for the first and/or the second component of the respectively adapted FE model.

The repeated adaptation of the FE model can be used to determine an optimized adapted FE model for which the degree of the spatial deformation of the first component and/or the second component is smaller than a predetermined deformation threshold value.

The device may also be configured to provide structural data for the optimized adapted FE model of the assembly, wherein the structural data allow production of the first component and/or of the second component. In other words, the optimized adapted FE model can be used to manufacture the first component and/or the second component. This makes it possible to reliably bring about the situation in which the assembly produced by welding together the first and the second component has a reduced degree of deformations.

According to a further aspect, a (computer-implemented) method for predicting and/or for reducing the deformation of an assembly brought about during production of at least one weld seam for connecting a first component and a second component of the assembly is described. In particular, in this respect the deformation of the (relatively easily deformable) second component can be predicted and/or reduced.

The method includes the providing of an FE model of the assembly, wherein the FE model comprises a set of FEs for the weld seam and a set of FEs for the first and the second component. Moreover, the method includes the inducing of a spatial contraction of the set of FEs for the weld seam. The contraction may be effected in the longitudinal direction of the weld seam. As an alternative or in addition, the contraction may be effected transversely and/or radially to the longitudinal direction of the weld seam.

The method also includes the simulating of the effect of the spatial contraction on the set of FEs for the first and/or the second component. In particular, the effects on the spatial extent of the set of FEs for the first and/or the second component can be determined. Moreover, the method includes the predicting of the spatial deformation of the first component and/or the second component on the basis of the simulated effect on the set of FEs for the first and/or the second component.

According to a further aspect, a software (SW) program is described. The SW program may be configured to be run on a processor (e.g., on a computer or server) and as a result to carry out the method described in the present document.

According to a further aspect, a storage medium is described. The storage medium may comprise an SW program which is configured to be run on a processor and as a result to carry out the method described in the present document.

It should be noted that the methods, devices and systems described in the present document can be used both individually and in combination with other methods, devices and systems described in the present document. Furthermore, any aspect of the methods, devices and systems described in the present document can be combined with one another in a wide variety of ways. In particular, the features of the claims can be combined with one another in a wide variety of ways.

The invention is described in more detail below on the basis of exemplary embodiments.

### BRIEF DESCRIPTION OF THE DRAWINGS

FIG. 1 shows an exemplary vehicle with a multipart assembly;

FIG. 2a shows a multipart assembly in a front view;

FIG. 2b shows a multipart assembly in a side view;

FIG. 3a shows an exemplary finite element model of a multipart assembly;

FIG. 3b shows an exemplary finite element; and

FIG. 4 shows a flow chart of an exemplary method for predicting and/or for avoiding or reducing deformations during the production of a multipart assembly.

### DETAILED DESCRIPTION OF THE DRAWINGS

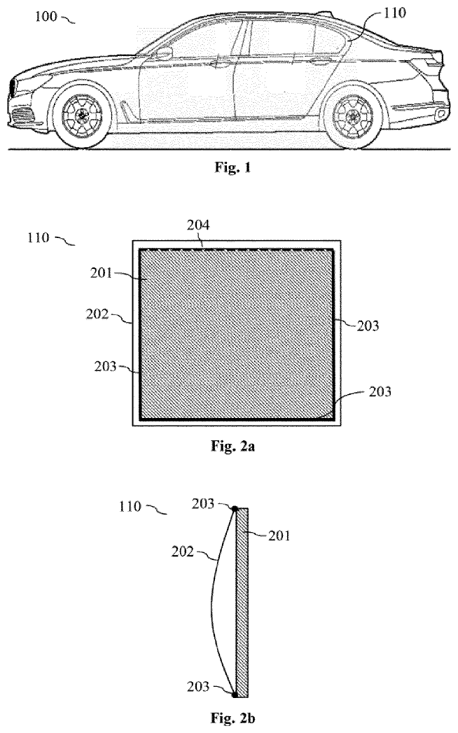

As presented in the introduction, the present document is concerned with the efficient and timely prediction and, if appropriate, avoidance and/or reduction of deformation during the production of a multipart assembly by means of a welding process. In this context, FIG. 1 shows a vehicle 100 with a vehicle door 110 as an example for a multipart assembly. Furthermore, FIG. 2a schematically shows a multipart assembly 110 in a front view (of the surface of the multipart assembly 110) and FIG. 2b shows the multipart assembly in a side view (of the edge between the different components 201, 202 of the assembly 110). The multipart assembly 110 may have, for example, a surface area of 0.5 m² or more.

The assembly 110 comprises a first component 201, which, for example, is designed to effect the mechanical stability of the assembly 110 (at least to a significant extent). Furthermore, the assembly 110 comprises a second component 202, which, for example, is designed to effect a decorative and/or shaping function of the assembly 110. When the component 110 is a vehicle door, it is possible for example the second component 202 to form an outer skin of the vehicle door. The first component 201 may have a relatively stiff form, while the second component 202 may be relatively easily deformable (e.g., on account of the use of a relatively thin metal sheet).

The first component 201 and the second component 202 may be connected to one another at one or more (elongate) edges. For example, the first component 201 and the second component 202 may be canted in to one another and/or pressed together at an edge 204. As an alternative or in addition, the first component 201 and the second component 202 may be welded to one another at one or more edges by way of linear weld seams 203 (e.g., by using a laser welding method and/or by using a tactile and/or remote welding method). For example, a respective weld seam 203 may be arranged at two or more edges of the assembly 110.

The connecting of the two components 201, 202 by way of one or more linear and/or elongate weld seams 203 may lead to stresses within the assembly 110, it being possible that the stresses bring about deformations in particular in the second component 202. The stresses may be caused in particular by the thermal influences in the course of the production and the cooling of the weld seams 203. The stresses and deformations caused thereby may be predicted, if appropriate, by specific measurements made on prototypes of the component 110 and/or by the use of complex thermomechanical simulation models.

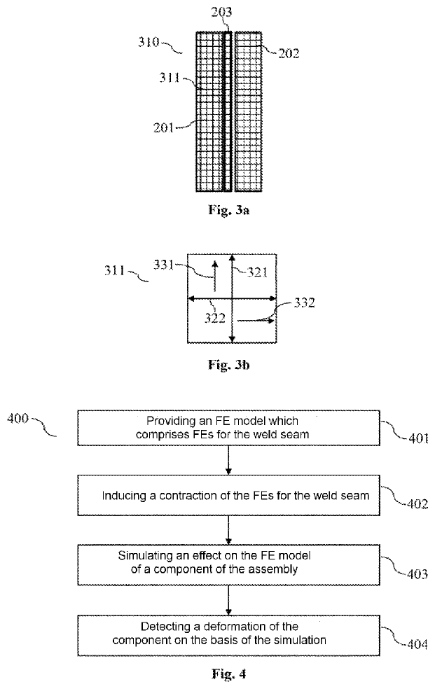

The individual components 201, 202 of an assembly 110 can be described by a finite element (FE) model 310, as illustrated by way of example in FIG. 3a. FIG. 3a shows, in particular, an FE model 310 for a detail of the component 110. In this respect, the first component 201 and the second component 202 are each described by a set of finite elements 311 that adjoin one another and may have, for example, a respective (three-dimensional) beam or cuboid structure. In other words, the volume of the individual components 201, 202 can be described by a two- or three-dimensional sequence of FEs 311.

Each individual FE 311 may (as illustrated in FIG. 3b) comprise a plurality of parameters, in particular geometric parameters 321, 322 for describing the spatial extent of the FE 311 and/or mechanical parameters 331, 332 for describing mechanical forces and/or tensions within the FE 311. Furthermore, an FE 311 may comprise a mathematical and/or mechanical model that describes how mechanical forces and/or tensions at edges of the FE 311 affect the spatial extent of the FE 311, and/or vice versa. Adjacent FEs 311 may interact with one another via edges which adjoin one another.

The FE model 310 may also comprise FEs 311 for modeling the one or more weld seams 203 for connecting the first component 201 to the second component 202. The FE model 310 of a weld seam 203 may comprise, for example, a (if appropriate, one-dimensional) sequence of FEs 311. In this case, the FE model 310 of a weld seam 203 is connected at a first (longitudinal) edge to the FE model 310 of the first component 201 and at an oppositely situated second (longitudinal) edge to the FE model of the second component 202 in such a way that a change in a parameter 321, 322, 331, 332 in an FE 311 of the weld seam 203 can have an effect on a parameter 321, 322, 331, 332 in an FE 311 of the first component 201 and/or of the second component 202.

In the basic state of the FE model 310, it can be assumed, if appropriate, that the FEs 311 of a weld seam 203 do not apply any forces and/or tensions 331, 332 to adjacent FEs 311 of the first component 201 and/or of the second component 202.

The effects of the welding process on a multipart assembly 110 can be simulated by means of the FE model 310 of the assembly 110. In particular, in the process the FE model 310 of a weld seam 203 can be induced to contract by a specific contraction factor (along the length of the weld seam 203 and/or transversely to the weld seam 203). For this purpose, the spatial extent 321 of the FE 311 of the FE model 310 of the weld seam 203 can be induced to reduce by a specific contraction factor (in the longitudinal direction and/or transversely to the longitudinal direction).

The contraction factor can be determined in advance by measurements and/or by thermomechanical simulations. In particular, in this respect, a first reference component with one or more first reference properties and a second reference component with one or more second reference properties can be connected to one another via at least one weld seam. Exemplary reference properties are:
the material of a component;
the thickness of a component; and
the modulus of elasticity of a component.

Characteristic data (e.g., in the form of a lookup table) which indicate the contraction factor to be used in each case for different combinations of first and second reference components can then be provided. In order to determine the contraction factor for a specific assembly 110, the reference properties of the first component 201 and the reference properties of the second component 202 can be determined, and then the value of the contraction factor can be determined from the characteristic data on the basis of the reference properties.

The contraction of the FEs 311 of the weld seam 203 brings about changes in the parameters 321, 322, 331, 332 of the FEs 311 of the first component 201 and/or the second component 202, which parameters can be determined on the basis of the FE model 310 of the assembly 110 in the course of an FE simulation. In particular, effects on the geometric parameters 321, 322 of the Fes 311 of the first component 201 and/or the second component 202 and therefore deformations of the first component 201 and/or of the second component 202 can be determined in the process.

It can therefore be determined on the basis of an FE simulation whether the generation of one or more weld seams 203 will lead to a (visible) distortion or to a (visible) deformation of the first component 201 and/or of the second component 202. If this is the case, a change can be made to the first component 201 and/or the second component 202 (in particular to the FE model 311 of the first and/or second component 201, 202). In the process, it is possible to adapt, for example, a material property (e.g., the material thickness) and/or the form of the first and/or the second component 201, 202. It is then possible to bring about a renewed contraction of the adapted FE model 310 of the one or more weld seams 203, in order to detect a possible deformation of the assembly 110. This adaptation process can be iteratively repeated.

An iterative adaptation of the FE model 310 of the first and/or of the second component 201, 202 makes it possible to determine an optimized FE model 310 for which no deformations or no significant (visible) deformations of the first and/or of the second component 201, 202 of the FE model 310 are brought about during the contraction of the one or more weld seams 203. The first and/or the second component 201, 202 and also the multipart assembly 110 can then be manufactured in a manner corresponding to the determined, optimized FE model 310. This makes it possible to efficiently and reliably produce a multipart assembly 110 with one or more weld seams 203, which do not have any deformations (that are significant and/or visible to the naked eye).

An assembly 110 may thus be virtually modeled in the initial state (by means of a CAD nominal geometry) before production of the one or more weld seams 203. In this respect, only the elements or components 201, 202 of the assembly 110 and not the installation elements and/or tool elements taking part in the process are modeled. In this respect, all weld seams 203 are part of the model 310 (e.g., in each case in the form of a line in the model 310). Data with respect to the tools and/or the installations for the generation of the weld seams 203 are not used. A weld seam 203 can be modeled here by means of finite elements 311 having material data with respect to properties of the material of the weld seam 203.

To simulate the welding process, the lengths of the one or more weld seams 203 are mechanically (without using heat sources and/or heat sinks) shrunk by a proportion as a percentage (i.e., by a contraction factor). In the process, in the course of the simulation a temporally distributed volume shrinkage as a percentage can be performed. The shrinkage may be applied in a distributed manner along the longitudinal propagation of a weld seam 203. An FE simulation of this type makes it possible to qualitatively and quantitatively assess the susceptibility of the assembly 110 to the emergence of warpages and/or to puncture problems. Furthermore, risk analyses for deformations that may result from other influences can be carried out.

FIG. 4 shows a flow chart of an exemplary (computer-implemented) method 400 for predicting and/or for reducing the deformation of an assembly 110 brought about during production of at least one (linear) weld seam 203 for connecting a first component 201 and a second component 202 of the assembly 110. The weld seam 203 may be produced, for example, by means of a welding tool, in particular using a laser welding process and/or by use of a tactile and/or remote welding process. The method 400 may be carried out by a computer and/or server (e.g., using an FE simulation software program and/or a CAD (Computer Aided Design) software program).

The method 400 includes the providing 401 of an FE model 310 of the assembly 110, the FE model 310 comprising a set of FEs 311 for the weld seam 203 and at least one set of FEs 311 for the first and the second component 201, 202. The set of FEs 311 for the weld seam 203 may comprise a linear sequence of FEs 311. In this respect, the FEs 311 of the weld seam 203 may be coupled in each case to at least one FE 311 of the first component 201 and one FE 311 of the second component 202, in particular in such a way that a deformation (in particular a contraction) of an FE 311 of the weld seam 203 brings about a tension and/or a force in an FE 311 of the first component 201 and/or of the second component 202.

Moreover, the method 400 comprises the inducing 402 of a spatial contraction of the set of FEs 311 for the weld seam 203. In this respect, the contraction may be effected along the linear propagation of the weld seam 203. In particular, the length of the weld seam 203 can be induced to reduce by a specific contraction factor. The reduction of the length of the weld seam 203 may be distributed (uniformly) over the individual FEs 311 for the weld seam 203.

The method 400 also includes the simulating 403 of the effect of the spatial contraction of the set of FEs 311 for the weld seam 203 on the set of FEs 311 for the first and/or the second component 201, 202. In particular, a simulation can be carried out (by means of an FE simulation program) as to which stresses 331, 332 and/or which spatial changes 321, 322 are brought about in the case of the individual FEs 311 of the first component 201 and/or the second component 202.

Moreover, the method 400 includes the predicting and/or forecasting 404 of the spatial deformation of the first component 201 and/or the second component 202 on the basis of the simulated effect on the set of FEs 311 for the first and/or the second component 201, 202.

The method 400 described makes it possible to efficiently (also without using a model of the welding installation and/or of the welding process) make a prediction as to what effect the welding process will have on the deformation of a multipart assembly 110. Furthermore, an iterative and/or repeated adaptation of the FE model 310 of the assembly 110 makes it possible to determine an FE model 310 in which the contraction of the weld seam 203 leads to a reduced deformation of the first and/or of the second component 201, 202. The first and/or the second component 201, 202 may then be manufactured on the basis of the adapted FE model 310, with the result that an assembly 110 can be produced with reduced deformations.

The present invention is not restricted to the exemplary embodiments shown. In particular, it should be noted that the description and the figures are intended to illustrate only the principle of the methods, devices and systems provided.

1.-11. (canceled)

12. An apparatus for predicting and/or reducing a deformation of an assembly (110) brought about during production of a weld seam (203) that connects a first component (201) and a second component (202) of the assembly (110), comprising:
a device, wherein the device is configured to:
determine and/or provide a finite element (FE) model (310) of the assembly (110), wherein the FE model (310) comprises a set of FEs (311) for the weld seam (203) and a set of FEs (311) for the first component (201) and the second component (202);
induce a spatial contraction of the set of FEs (311) for the weld seam (203);
determine an effect of the spatial contraction on the set of FEs (311) for the first component (201) and/or the second component (201, 202); and
predict a spatial deformation of the first component (201) and/or of the second component (202) on a basis of the effect on the set of FEs (311) for the first component (201) and/or the second component (202).

13. The apparatus according to claim 12, wherein the weld seam (203) extends linearly between the first component (201) and the second component (202) and wherein the set of FEs (311) for the weld seam (203) comprises a linear sequence of FEs (311) that corresponds to the weld seam (203).

14. The apparatus according to claim 12, wherein the device is configured to:
bring about a spatial contraction by a contraction factor; and
apply the contraction factor to individual FEs (311) of the set of FEs (311) for the weld seam (203); and/or
distribute the spatial contraction uniformly over the set of FEs (311) for the weld seam (203).

15. The apparatus according to claim 12, wherein the device is configured to:
determine one or more reference properties of the first component (201) and/or of the second component (202); and
determine a degree of the spatial contraction to be induced on a basis of the one or more reference properties of the first component (201) and/or the second component (202).

16. The apparatus according to claim 15, wherein the one or more reference properties include:
a material of the first component (201) and/or of the second component (202); and/or
a material thickness of the first component (201) and/or of the second component (202).

17. The apparatus according to claim 15, wherein:
the device is configured to determine the degree of the spatial contraction to be induced on a basis of predetermined characteristic data; and
the predetermined characteristic data indicate a respective degree of the spatial contraction to be induced for a multiplicity of combinations of one or more different reference properties of a first reference component and/or a second reference component.

18. The apparatus according to claim 12, wherein the device is configured to:
repeatedly adapt the FE model (310) of the assembly (110) for the first component (201) and/or for the second component (202) in order to determine an adapted FE model (310);
repeatedly induce a spatial contraction of the set of FEs (311) for the weld seam (203) of the adapted FE model (310);
repeatedly determine an effect of the spatial contraction on the set of FEs (311) for the first component (201) and/or the second component (202) of the adapted FE model (310); and
repeatedly determine a degree of the spatial deformation of the first component (201) and/or the second component (202) on a basis of the effect on the set of FEs (311) for the first component (201) and/or the second component (202) of the adapted FE model (310);
in order to determine an optimized adapted FE model (310) for which the degree of the spatial deformation of the first component (201) and/or the second component (202) is smaller than a predetermined deformation threshold value.

19. The apparatus according to claim 18, wherein the device is configured to provide structural data for the optimized adapted FE model (310) of the assembly (110) that allow production of the first component (201) and/or the second component (202).

20. The apparatus according to claim 18, wherein the device is configured to adapt a geometric form and/or a material property of the first component (201) and/or of the second component (202) in order to determine the adapted FE model (310).

21. The apparatus according to claim 12, wherein the set of FEs (311) for the weld seam (203) describes an entirety of the weld seam (203) between the first component (201) and the second component (202) already at a beginning of an FE simulation for determining the effect of the spatial contraction on the set of FEs (311) for the first component (201) and/or the second component (202).

22. A method (400) for predicting and/or reducing a deformation of an assembly (110) brought about during production of a weld seam (203) that connects a first component (201) and a second component (202) of the assembly (110), comprising the steps of:
providing (401) a finite element (FE) model (310) of the assembly (110), wherein the FE model (310) comprises a set of FEs (311) for the weld seam (203) and a set of FEs (311) for the first component (201) and the second component (202);
inducing (402) a spatial contraction of the set of FEs (311) for the weld seam (203);
simulating (403) an effect of the spatial contraction on the set of FEs (311) for the first component (201) and/or the second component (202); and
predicting (404) a spatial deformation of the first component (201) and/or of the second component (202) on a basis of the simulated effect on the set of FEs (311) for the first component (201) and/or the second component (202).
